(19) United States
(12) Patent Application Publication
(10) Pub. No.: US 2009/0129355 A1
(43) Pub. Date: May 21, 2009

(54) APPARATUS OF TRANSMITTING PACKETS OF WIRELESS LOCAL NETWORK AND METHOD FOR USING THE SAME

(75) Inventor: YUH-CHUN LIN, HSINCHU COUNTY (TW)

Correspondence Address: WPAT, PC;INTELLECTUAL PROPERTY ATTORNEYS, 2030 MAIN STREET, SUITE 1300, IRVINE, CA, 92614, US

(73) Assignee: RALINK TECHNOLOGY CORPORATION, HSINCHU COUNTY (TW)

(21) Appl. No.: 12/273,052

(22) Filed: Nov. 18, 2008

(30) Foreign Application Priority Data
Nov. 21, 2007 (TW) 096144012

(51) Int. Cl. H04W 8/00

(52) U.S. Cl. 370/338

(57) ABSTRACT

An apparatus for transmitting packets of a wireless local area network comprises a packet buffer area, a host controller and a timer. The packet buffer area is configured to temporarily store a plurality of packets. The host controller is configured to aggregate and control the plurality of packets in the packet buffer area. The timer is used to determine whether there are time-limited packets in the packet buffer area. While the host controller is aggregating the packets in the packet buffer area, an aggregation busy flag is enabled; and when the packet buffer area is outputting the time-limited packets, a timer busy flag is enabled.

### BACKGROUND OF THE INVENTION

1. Field of the Invention

The present invention relates to an apparatus and method for transmitting packets of a wireless local area network (WLAN), and more particularly, to an apparatus and method for transmitting packets of a WLAN in an aggregation manner.

2. Description of the Related Art

With the development of the wireless network transmission, users are no longer restricted to a fixed place to connect to the Internet. As long as a wireless base station is close to the user's portable computer, the user can connect it to the Internet accordingly.

Secure Digital Input/output (SDIO) WLAN adapter is a well-known wireless network protocol interface, especially for smaller portable electronic devices with embedded Microsoft (MS) Windows mobile operating system, such as PDA. When not transmitting or receiving packets, the SDIO WLAN adapter remains in listening mode so as to reduce unnecessary power consumption. During the transmission of normal SDIO signals, when an SDIO host controller sends a packet out, the driver will subsequently send an SDIO bus request so as to execute corresponding hardware actions. However, the SDIO bus requests routinely occupy too much bandwidth of the SD bus. In accordance with experimental statistic, one SDIO bus request normally requires an average of 100 Kbps of bandwidth.

Because the bandwidth of the system bus directly affects the speed with which the user connects and receives data from the Internet, it is necessary to improve this drawback in the current technology suppress.

### SUMMARY OF THE INVENTION

The present invention provides an apparatus and a method to transmit WLAN packets. A packet buffer area is established to store transmitting packets. When the number of the transmitting packets reaches a threshold, the packets in the packet buffer area are transmitted in a transmit aggregation process so as to conserve the bandwidth needed for bus requests.

The apparatus for transmitting packets of a wireless local area network in accordance with one embodiment of the present invention comprises a packet buffer area, a host controller and a timer. The packet buffer area is configured to temporarily store a plurality of packets. The host controller is configured to aggregate and control the plurality of packets in the packet buffer area. The timer is used to determine whether there are any time-limited packets in the packet buffer area. When the host controller is aggregating the packets in the packet buffer area, an aggregation busy flag is enabled; and when the packet buffer area is outputting the time-limited packets, a timer busy flag is enabled.

The method for transmitting packets of a wireless local area network in accordance with one embodiment of the present invention comprises the steps of: utilizing a host controller to aggregate a plurality of packets in a packet buffer area; utilizing a timer to detect time-limited packets; enabling an aggregation busy flag if the host controller intends to aggregate output packets and a timer busy flag is off; stopping output of time-limited packets if the aggregation busy flag is enabled; enabling the timer busy flag if time-limited packets are present and aggregation busy flag is off; and stopping output of packets if the timer busy flag is enabled.

The method for transmitting packets of a wireless local area network in accordance with one embodiment of the present invention comprises the steps of: setting a packet buffer area; utilizing a host controller to aggregate a plurality of transmitting packets in the packet buffer area; outputting the packets in the packet buffer area if the cascaded length of transmitting packets is larger than a predetermined number; outputting the packets in the packet buffer area if the number of transmitting packets is larger than a predetermined number; and outputting the packets in the packet buffer area if the packet buffer area contains time-limited packets.

### BRIEF DESCRIPTION OF THE DRAWINGS

The invention will be described according to the appended drawings in which:

FIG. 1 shows an apparatus of transmitting WLAN packets according to one embodiment of the present invention;

FIG. 2 shows a format of transmitting packets in the packet buffer area 11 according to one embodiment of the present invention;

FIG. 3 illustrates an example of the transmit descriptor; and

FIG. 4 shows a method of transmitting WLAN packets according to one embodiment of the present invention.

### PREFERRED EMBODIMENT OF THE PRESENT INVENTION

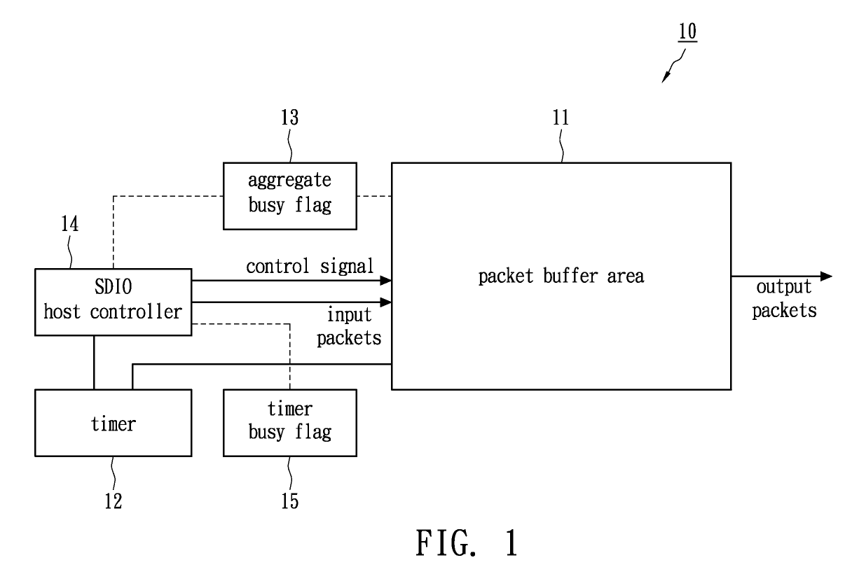

FIG. 1 shows an apparatus of transmitting WLAN packets according to one embodiment of the present invention. The apparatus 10 includes a SDIO host controller 14, a packet buffer area 11 and a timer 12. To avoid the disadvantage of prior art that makes one SDIO bus request per packet transmission, the present invention establishes a packet buffer area 11, whose capacity may be from several to hundreds of packets. The SDIO host controller 14 stores the packets intended for transmission in the packet buffer area 11 until a specific condition is satisfied. By using the mechanism, the number of generated SDIO requests is reduced such that the unnecessary bandwidth cost can be largely eliminated. When the SDIO host controller 14 is handling the aggregation of packets and storing them into the packet buffer area 11, meanwhile an aggregation busy flag is enabled so as to prevent the packet buffer area 11 from outputting packets. Generally, an authorization process is commonly seen in accessing network packets, and during the authorization process some transmitting packets such as management frames possess the characteristic of limited response time. If the response is not made in a predetermined period, it will be treated as a failure. The timer 12 of this embodiment conducts a polling about whether there are any time-limited transmitting packets within a constant period. If the answer is affirmative and the SDIO host controller does not conduct aggregation of packets, then the packets in the packet buffer area 11 are transmitted. When the timer 12 enables the output of the packet buffer area 11, the timer busy flag 15 is enabled so as to prevent the SDIO host controller 14 from conducting aggregation of packets in the packet buffer area 11. In other words, to prevent data disorder caused by a situation in which the SDIO is conducting aggregation of packets while the timer 12 is also outputting the packets in the packet buffer area 11, while the SDIO controller conducts aggregation of packets and the timer busy flag 15 is off, then the aggregation busy flag 13 is enabled. Even if there are some time-limited packets inside the packet buffer area 11, they still need to wait for disabling of the aggregation busy flag 13 until being outputted. In contrast, to prevent data disorder caused by a situation in which the packet buffer area is outputting packets while the SDIO controller conducts aggregation of packets directly, when the SDIO controller 14 finds that there are time-limited packets in the packet buffer area 11 and the aggregation busy flag 13 is off, then it will enable the timer busy flag 15 and output packets. After the timer busy flag 15 is enabled, the SDIO host controller will conduct the aggregation of packets in the packet buffer area 11 until the timer busy flag 15 is turned off.

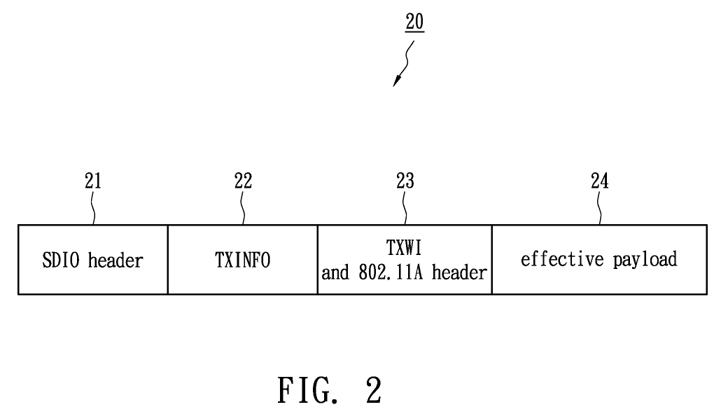

FIG. 2 shows a format of transmitting packets in the packet buffer area 11 according to one embodiment of the present invention. The content of the format includes an SDIO header 21, transmit information (TXINFO) 22, transmit wireless information (TXWI) and 802.11 header 23, and a payload 24 in sequence. The length of the SDIO header 21 can be 4 bytes and used to record the length of transmitting packets, which is the sum of the length of the transmit information 22, the transmit wireless information and 802.11 header 23 and effective payload 24. The length of the transmit information is 4 bytes. The length of the transmitting wireless information and 802.11 header 23 is recorded in the SDL0 field of the second double word of the transmit descriptor of the transmitting packets. The length of the effective payload 24 is recorded in the SDL1 field of the second double word of the transmit descriptor of the transmitting packets.

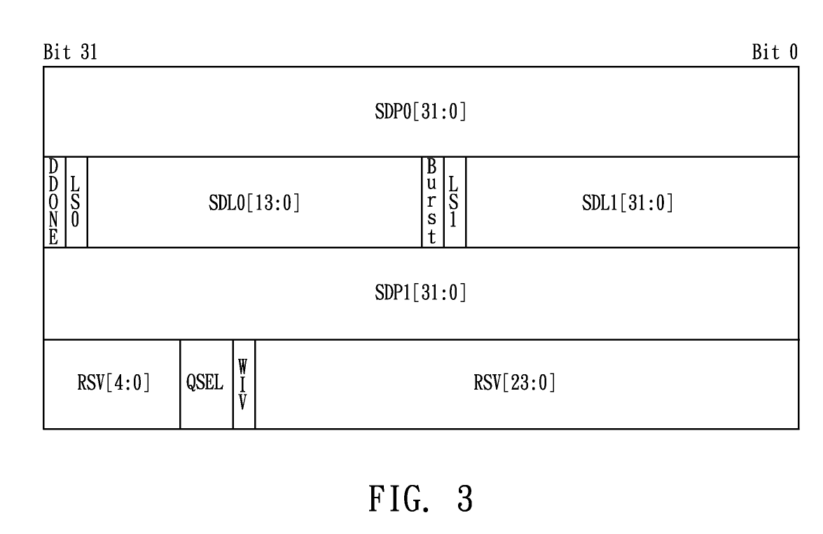

FIG. 3 illustrates an example of the transmit descriptor, where SDP0 indicates a block data pointer, SDL0 indicates the length of the data pointed by the SDP0, SDP1 indicates a block data pointer, SDL1 indicates the length of the data pointed by SDP1, LS0 indicates the last sector of the data pointed by SDP0, and LS1 indicates the last sector of the data pointed by SDP1.

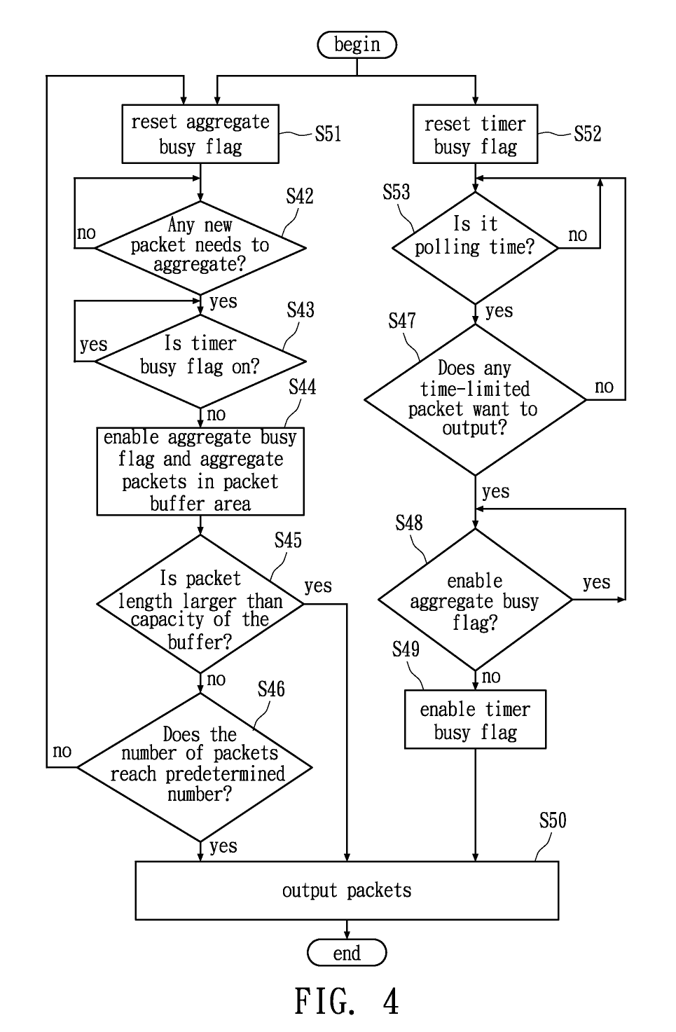

FIG. 4 shows a method of transmitting WLAN packets according to one embodiment of the present invention. Because the aggregation transmitting process and the transmit polling timer deal with the same buffer area, to avoid conflicts of resource accessibility, one embodiment of the present invention can set up two mechanisms such as two flags to coordinate the mutual influence. For example, if the polling timer runs out of a fixed time interval, but at that time the aggregation transmitting process is transmitting packets, the polling timer withholds the packet transmission. If the aggregation transmitting process intends to proceed but the polling timer is transmitting packets, then the aggregation transmitting process is withheld. In Step S51, the aggregation flag is reset first. In Step S42, it is determined whether any new packet needs to be aggregated. If affirmative, Step S43 is entered to determine whether the timer busy flag is on. The process enters Step 44 until the timer busy flag is off. In Step S44, the aggregation busy flag is enabled and packets are aggregated in the packet buffer area. In Step S45, it is determined whether the length of the packets is larger than the capacity of the packet buffer area. If affirmative, Step S50 is entered and the packets are outputted; otherwise, Step S46 is entered to determine whether the number of packets reaches a predetermined value. If the answer of Step S46 is affirmative, Step S50 is entered to output packets. In Step S52, the timer busy flag is reset. In Step S53, it is determined whether it is the right time to poll. If affirmative, Step S47 is entered. In Step S47, it is determined whether there are any time-limited packets to transmit. If affirmative, Step S48 is entered to determine whether the aggregation busy flag is on. If affirmative, keep waiting; otherwise, Step S49 is entered to enable the timer busy flag and output packets in Step S50. Timer polling is an example to implement the present invention, and as known by persons skilled in the art, there are other methods to implement the present invention.

Regarding the method to examine the aggregation transmitting process, one embodiment of the present invention is illustrated as below. First, the transmitting packets are examined. If the cascaded block length of the transmitting packets exceeds the capacity of the packet buffer area 11 or the number of the transmitting packets is greater than a predetermined value, the packets in the packet buffer area 11 are transmitted. While being allocated in the packet buffer area 11, the transmitting packets may conduct an alignment in accordance with a block size. If the data in the transmitting packet is not enough to fill up the block size, a series of zeroes may be entered to fill up the block size. Therefore, based on the alignment of the last packet, the first content of the next packet, i.e., the SDIO header 21 and the following data will follow the same alignment rule.

The embodiment of the present invention need not modify the design of an SDIO controller, but rather designs a driver of the SDIO controller to implement the aggregated-type packet transmission. In accordance with simulations, under the same condition of 802.11 WLAN, the bandwidth of the embodiment of the present invention increases from 2.841 Mbps to 3.693 Mbps, approximately 30% improvement.

The above-described embodiments of the present invention are intended to be illustrative only. Numerous alternative embodiments may be devised by persons skilled in the art without departing from the scope of the following claims.

What is claimed is:

1. An apparatus for transmitting packets of a wireless local area network, comprising:
a packet buffer area configured to temporarily store a plurality of packets;
a host controller configured to aggregate and control the plurality of packets in the packet buffer area; and
a timer for determining whether there are time-limited packets in the packet buffer area;
wherein when the host controller is aggregating the packets in the packet buffer area, an aggregation busy flag is enabled; and when the packet buffer area is outputting the time-limited packets, a timer busy flag is enabled.

2. The apparatus of claim 1, wherein the timer is operative in a polling manner.

3. The apparatus of claim 1, wherein the host controller waits to aggregate the packets of the packet buffer area until the timer busy flag is disabled.

4. The apparatus of claim 1, wherein the time-limited packets are delayed to be outputted until the aggregation busy flag is disabled.

5. The apparatus of claim 1, wherein if the length of cascaded blocks of transmitting packets is larger than the capacity of the packet buffer area, then the packet buffer area outputs the packets therein.

6. The apparatus of claim 1, wherein if the number of transmitting packets is larger than a predetermined number, the packet buffer area outputs the packets therein.

7. The apparatus of claim 1, wherein the transmitting packets in the packet buffer area are aligned based on a block size.

8. The apparatus of claim 7, wherein if the transmitting packets are not large enough to fill up the block size, a series of zeroes is added to fill up the block.

9. The apparatus of claim 8, wherein the time-limited packets are certified management frames.

10. The apparatus of claim 1, wherein the content of the transmitting packets includes:
a secure digital input/output (SDIO) header having four bytes;
a transmit information having four bytes;
a transmit wireless information and 802.11 header; and
a transmit payload.

11. A method for transmitting packets of a wireless local area network, comprising the steps of:
aggregating a plurality of packets in a packet buffer area with a host controller;
detecting time-limited packets with a timer;
enabling an aggregation busy flag if the host controller intends to aggregate output packets and a timer busy flag is off;
stopping outputting time-limited packets if the aggregation busy flag is enabled;
enabling the timer busy flag if time-limited packets are present and aggregation busy flag is off; and
stopping outputting packets if the timer busy flag is enabled.

12. The method of claim 11, further comprising the step of outputting the packets in the packet buffer area if the cascaded length of transmitting packets is larger than a predetermined number.

13. The method of claim 11, further comprising the step of outputting the packets in the packet buffer area if the number of transmitting packets is larger than a predetermined number.

14. The method of claim 11, further comprising the step of examining in a fixed interval whether the packet buffer area contains time-limited packets.

15. The method of claim 11, wherein the transmitting packets in the packet buffer area are aligned based on a block size.

16. The method of claim 15, wherein if the transmitting packets fail to fill up the block size, a series of zeroes are added to fill up the block.

17. A method for transmitting packets of a wireless local area network, comprising the steps of:
setting a packet buffer area;
aggregating a plurality of transmitting packets in the packet buffer area with a host controller;
outputting the packets in the packet buffer area if the cascaded length of transmitting packets is larger than a predetermined number;
outputting the packets in the packet buffer area if the number of transmitting packets is larger than a predetermined number; and
outputting the packets in the packet buffer area if the packet buffer area contains time-limited packets.

18. The method of claim 17, further comprising the step of examining in a fixed interval whether the packet buffer area contains time-limited packets.

19. The method of claim 17, further comprising the step of enabling an aggregation busy flag if the host controller intends to aggregate output packets.

20. The method of claim 17, further comprising the step of enabling a timer busy flag if the time-limited packets are set to be outputted.
